(19) United States
(12) Patent Application Publication
(10) Pub. No.: US 2006/0008919 A1
(43) Pub. Date: Jan. 12, 2006

(54) Method and apparatus for detecting gas/radiation that employs color change detection mechanism

(76) Inventors: Yoke Peng Boay, Penang (MY); Kean Loo Keh, Penang (MY); Chin Hin Oon, Penang (MY); Selvan Maniam, Penang (MY); King Wai Wong, Penang (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/888,325

(22) Filed: Jul. 9, 2004

(51) Int. Cl. G01N 21/00

(52) U.S. Cl. 436/164; 422/86

(57) ABSTRACT

Method and apparatus for detecting the presence of an analyte (e.g., gas/radiation) that utilizes color change detection mechanisms. The apparatus has an indicator that changes color in the presence of the analyte. For example, in the absence of the analyte, the indicator reflects a first color. In the presence of the analyte, the indicator reflects a second color. The apparatus includes a color sensor that receives light reflected from the indicator and based thereon generates one or more signals that represent the reflected light. The apparatus also includes a color change detection mechanism that is coupled to the color sensor and that receives the signal generated by the color sensor and based on the signal determines whether the indicator has changed to the second color. Once it is determined that the indicator has changed to the second color, an alarm can be generated or remedial measures can be initiated.

### BACKGROUND OF THE INVENTION

Potentially dangerous gas mixtures (e.g. combustible gases and toxic gases,), particulates, etc. are found in many work place environments. These dangers are well known and monitoring instruments are available to detect a wide range of potential hazards.

A gas detector is a device that is used to detect the presence of a particular gas in an environment. For example, a gas detector can be deployed to ensure the safety of employees, who may be exposed to hazardous gases. An exemplary environment where hazardous gases may be accidentally released is a chemical manufacturing plant. Some examples of gas detectors include non-dispersive infrared sensor, ion mobility spectrometer, photo ionization detector, and electrochemical sensor.

A radiation detector is a device that is used to detect the presence of radiation in an environment. For example, a radiation detector can be deployed to ensure the safety of employees, who may be exposed to radiation. Some exemplary environments where radiation may be accidentally released into the environment include a nuclear reactor plant and a work site, where the handling of nuclear material occurs (e.g., hospital, research facilities, etc.).

It is well known that emissions from radioactive materials, alpha and beta particles and gamma rays, are extremely dangerous to both plants and animals. Various means to detect the presence of radioactive materials have been developed. One of the most common and well-known radiation measuring apparatuses is the Geiger counter. The Geiger counter detects the ionization that occurs in the atmosphere due to the presence of alpha and beta particles and gamma rays. Some other examples of radiation detectors include ionization chamber, proportional counter, scintillation detector, semiconductor diode detector, and dosimeter.

One disadvantage of these approaches is that many of these prior art detectors are not portable. Instead, these prior art approaches are large machines that are placed on or mounted to the ground. Additionally, these large machines typically require a high-energy source (e.g., an AC wall outlet). As can be appreciated, these types of detectors are not suitable for “in-the-field” applications (e.g., fire-fighters, rescue personnel, etc. who are on site and require a portable solution).

Another disadvantage of these approaches is that many of these prior art detectors require accurate and constant calibration. The calibration process varies with each type of sensor and instrument, but most processes involve matching the output of the instrument to a known value, usually a test mixture. The calibration process can be complex since these detectors typically measure the gas or radiation in terms of part per million (ppm). As can be appreciated, the required calibration/maintenance incurs undesirable human costs and monetary expenses. Furthermore, the measurement of whether the presence of a gas or radiation is present may be affected by environmental conditions and factors, such as, humidity, pressure and temperature, thereby adversely affecting the accuracy and effectiveness of these prior art detectors.

Based on the foregoing, there remains a need for a method and apparatus for detecting gas/radiation that overcomes the disadvantages set forth previously.

### SUMMARY OF THE INVENTION

According to one embodiment of the present invention, a method and apparatus for detecting the presence of an analyte (e.g., gas/radiation) that utilizes a color change detection mechanism are described. The apparatus has an indicator that changes color in the presence of the analyte. For example, in the absence of the analyte, the indicator reflects a first color. In the presence of the analyte, the indicator reflects a second color. The apparatus includes a color sensor that receives light reflected from the indicator and based thereon generates one or more signals that represent the reflected light. The apparatus also includes a color change detection mechanism that is coupled to the color sensor and that receives the signal generated by the color sensor and based on the signal determines whether the indicator has changed to the second color. Once it is determined that the indicator has changed to the second color, an alarm can be generated or remedial measures can be initiated.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a gas detector according to the invention that employs color change detection technology.

FIG. 2 illustrates a radiation detector according to the invention that employs color change detection technology.

FIG. 3 illustrates a block diagram of color change detection mechanism according to one embodiment of the invention.

FIG. 4 is a flow chart illustrating the processing steps performed by the color change detection mechanism of FIG. 3 according to one embodiment of the invention.

### DETAILED DESCRIPTION

A method and apparatus for detecting the presence of gas/radiation that employ color change detection mechanisms are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Gas Detector with Color Change Detection Technology

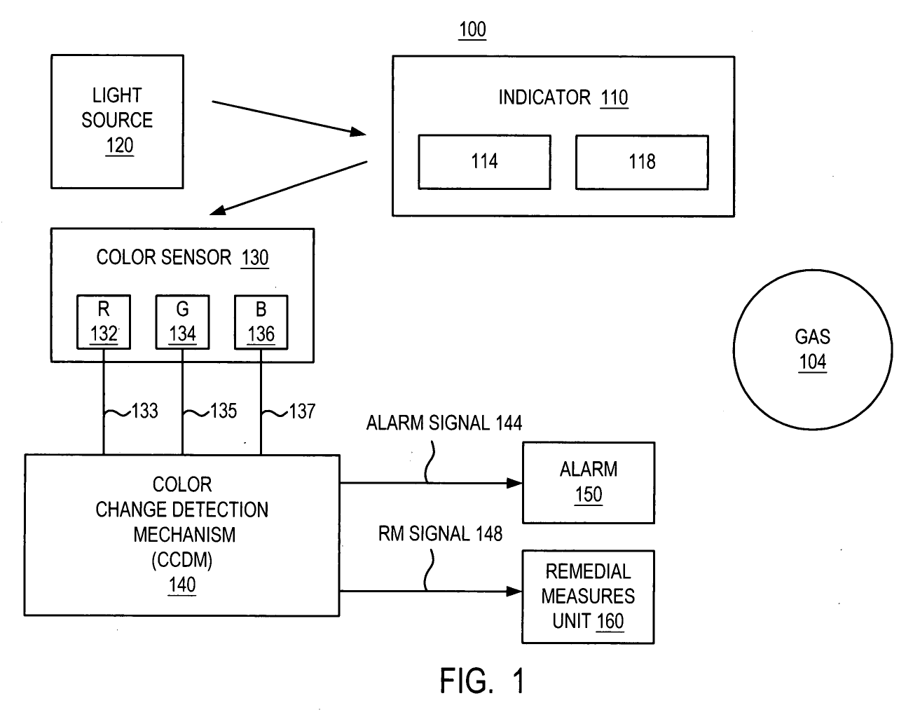

FIG. 1 illustrates a gas detector 100 according to the invention that employs color change detection technology. The gas detector 100 (hereinafter also referred to as “gas monitor”) is utilized to detect the presence of a gas 104 (hereinafter referred to also as “target gas”). The gas 104 can be, for example, an element of the periodic table or a gas molecule made from one or more of the elements from the periodic table. The gas detector 100 includes an indicator 110, a color sensor 130, and a color change detection mechanism (CCDM) 140.

The indicator 110 changes from a first color 114 to a second color 118 (also referred to as a “target color”) when exposed to the gas 104. For example, the indicator 110 reflects the first color 114 in the absence of gas 104 and reflects the second color 118 in the presence of the gas 114. The first color 114 can be a first predetermined color (e.g., white) that represents a non-reactive state (i.e., no gas has been detected). The second color 118 can be a second predetermined color (e.g., red) that represents a reactive state (i.e., gas has been detected).

The gas detector 100 operates in the following manner. When a gas is present in an open area (e.g., a factory floor) or in a closed area (e.g., a room or chamber), the indicator 110 changes color. For example, the indicator 110 can include or be coated with a chemical that changes color when a particular analyte is present. For example, the analyte can cause a chemical interaction or reaction with the chemical, thereby causing the chemical to change color. The composition, manufacture, and use of these types of chemicals are known by those of ordinary skill in the art. For example, colorimetric direct read monitors that utilize the above chemicals are available from AFC International, Inc. of DeMotte, Ind.

The light source 120 is optionally provided to illuminate the indicator 110 (e.g., to shine light beams or rays at the indicator 110). In one embodiment, the light source 120 is implemented with one or more light emitting diodes (LEDs) that emit a white light. It is noted that the light source 120 may need to be replaced or otherwise calibrated after a predetermined period of operation (e.g., 6 months) to correct any degradation in the performance of the light source 120.

The light is then reflected from the indicator 110 and received by the color sensor 130. The color sensor 130 can include, but is not limited to, a red sensor 132 for generating a first signal 133 (e.g., a first voltage signal) corresponding to red light received by the red sensor 132, a green sensor 134 for generating a second signal 135 (e.g., a second voltage signal) corresponding to green light received by the green sensor 134, and a blue sensor 136 for generating a third signal 137 (e.g., a third voltage signal) corresponding to blue light received by the blue sensor 136.

The color sensor 130 generates one or more signals that represent the light received by the sensor 130. The color sensor 130 according to the invention employs three color channels to detect color light. In one embodiment, the color sensor 130 includes a plurality of color sensors (e.g., a red color sensor, a green color sensor, and a blue color sensor). In another embodiment, the color sensor 130 can be implemented with a single integrated circuit that receives light and generates three inputs: a first signal representing the red component of the received light, a second signal representing the green component of the received light, and a third signal representing the blue component of the received light.

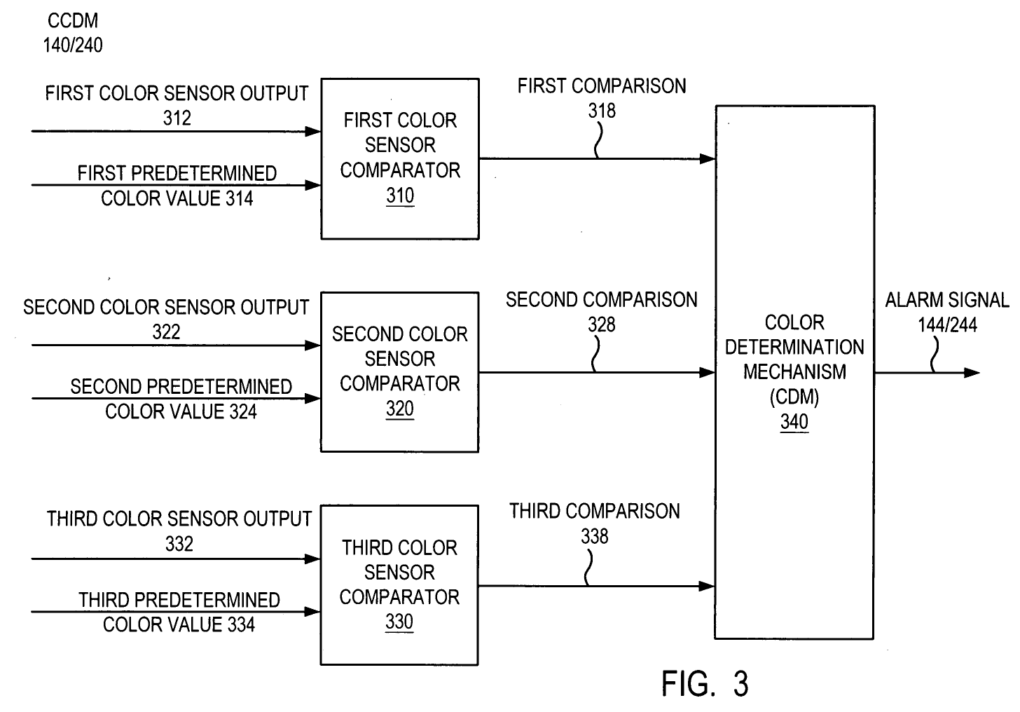

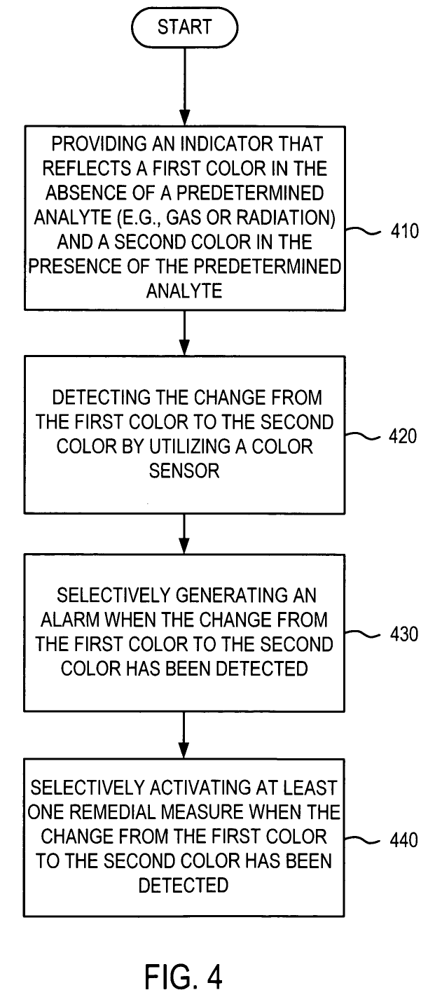

The CCDM 140 is coupled to the color sensor 130 and receives the signal(s) generated by the color sensor 140. For example, the color change detection mechanism (CCDM) 140 receives the first signal 133, second signal 135 and third signal 137 from the color sensor 130 and based thereon determines whether the color of the indicator 110 has changed to the target color 118. In one embodiment, the CCDM 140 compares the color sensor signals (133, 135, 137) with reference signals that correspond to the target color 118 and based on this comparison determines whether the color of the indicator 110 has changed to the target color 118. The color change detection mechanism (CCDM) 140 is described in greater detail hereinafter with reference to FIG. 3 and FIG. 4.

When it has been determined that the color of the indicator 110 has changed to the target color 118, the CCDM 140 can optionally assert an alarm signal 144. The alarm 150 is optionally provided and coupled to the CCDM 140 to receive the alarm signal 144. When the alarm signal 144 is asserted, the alarm 150 generates notifies those in the vicinity of the gas that the presence of the gas has been detected. The alarm 150 can be, but is not limited to, a visual alarm that generates a visual alert or cue, an audible alarm that generates an audible alert or cue, and other alarm (e.g., an alarm incorporated into a pager or cellular telephone that vibrates when a gas is detected).

When it is determined that the indicator has changed to the target color 118, the CCDM 140 can also selectively assert a remedial measure (RM) signal 148. The remedial measures unit 160 is optionally provided and coupled to the CCDM 140 to receive the RM signal 148. When the RM signal 148 is asserted, the remedial measures unit 160 initiates one or more remedial measures (e.g., venting the area, stopping the manufacturing process, etc.) to eliminate or mitigate the presence of the gas.

In this manner, the CCDM 140 according to the invention can detect various analyte (e.g., gases). The gases can include, but is not limited to, Acetone, Ammonia, Carbon disulfide, Carbon monoxide, Chlorine, Chlorine dioxide, Ethanol, Formaldehyde, Glutaraldehyde, Hydrazine, Hydrogen sulfide, Mercury, Methanol, Methyl ethyl ketone, Methyl isobutyl ketone, Nitrogen dioxide, Ozone, and Sulfur dioxide.

In another embodiment, the gas detector or monitor can include one or more color sensors, a signal processing means for processing the output of the color sensors, and an output. The color sensors provide an electrical response that varies with the presence or absence of the analyte being detected. For each sensor, there is also associated circuitry for driving the sensor, for measuring and displaying and/or recording the output, and for activating visual, vibrational or audible alarms that notify the user of the presence of a potentially hazardous condition.

In another embodiment, the color sensor 130 is integrated with the CCDM 140. In this embodiment, the CCDM 140 employs the color sensor 130 to receive light reflected from the indicator 110 and based thereon to generate one or more signals that represent the received light. The CCDM 140 then utilizes the signals generated by the color sensor 130 to determine whether the indicator 110 has changed to the target color 118. Once it is determined that the analyte is present, the CCDM 140 can generate an alarm signal 144 to activate an alarm 150 or a remedial signal 148 to initiate remedial measures 160. In yet another embodiment, both the color sensor 130 and the light source 120 are integrated with the CCDM 140.

Radiation Detector

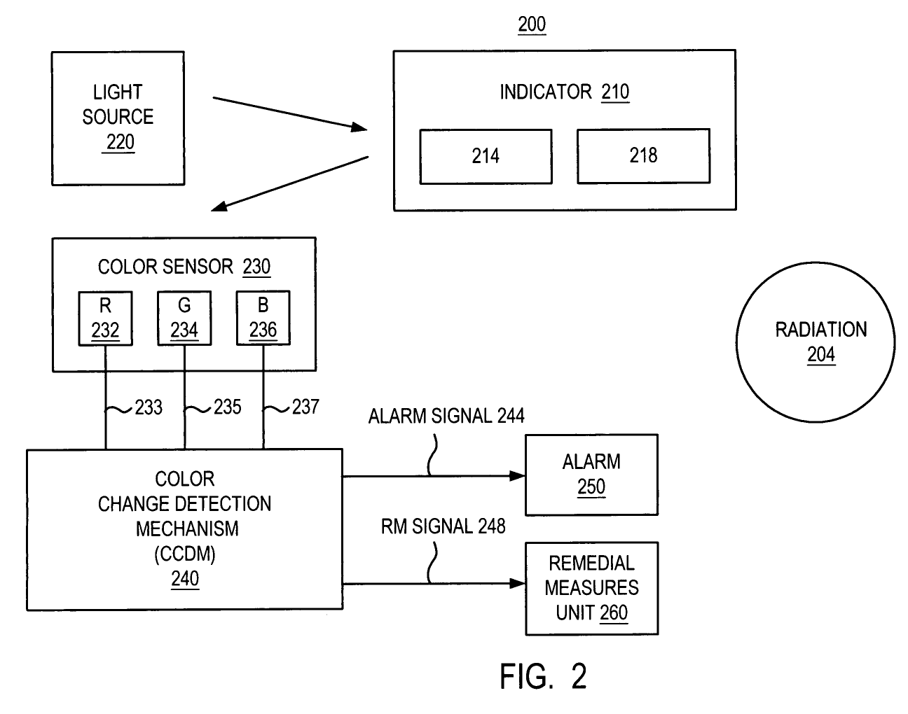

FIG. 2 illustrates a radiation detector according to the invention that employs color sensor. The radiation detector 200 is utilized to detect the presence of radiation 204. The radiation 204 can be, for example, an isotope of an element of the periodic table or an isotope of a molecule made from one or more of the elements from the periodic table. Radioactive materials are known to emit alpha particles, beta particles and gamma rays. In this regard, radiation can also include, for example, alpha particles, beta particles, and gamma rays. The radiation detector 200 includes an indicator 210, a color sensor 230, and a color change detection mechanism (CCDM) 240.

The indicator 210 changes from a first color 214 to a second color 218 (also referred to as a “target color”) when exposed to the radiation 204. The first color 214 can be a first predetermined color (e.g., white) that represents a non-reactive state (i.e., no radiation has been detected). The second color 218 can be a second predetermined color (e.g., red) that represents a reactive state (i.e., radiation has been detected).

The radiation detector 200 operates in the following manner. When radiation 204 is present in an open area (e.g., a factory floor) or in a closed area (e.g., a room or chamber), the indicator 210 changes color. For example, the indicator 210 can include or be coated with a chemical that changes color when radiation is present. For example, the radiation can cause a chemical interaction or reaction with the chemical, thereby causing the chemical to change color.

The light source 220 is optionally provided to illuminate the indicator 210 (e.g., to shine light beams or rays at the indicator 210). In one embodiment, the light source 220 is implemented with one or more light emitting diodes (LEDs) that emit a white light. It is noted that the light source 220 may need to be replaced or otherwise calibrated after a predetermined period of operation (e.g., 6 months) to correct any degradation in the performance of the light source 220.

The light is then reflected from the indicator 210 and received by the color sensor 230. The color sensor 230 can include, but is not limited to, a red sensor 232 for generating a first signal 233, corresponding to red light received by the red sensor 232, a green sensor 234 for generating a second signal 235, corresponding to green light received by the green sensor 234, and a blue sensor 236 for generating a third signal 237, corresponding to blue light received by the blue sensor 236.

The color sensor 230 generates one or more signals that represent the light received by the sensor 230. The color sensor 230 according to the invention employs three color channels to detect color light. In one embodiment, the color sensor 230 includes a plurality of color sensors (e.g., a red color sensor, a green color sensor, and a blue color sensor). In another embodiment, the color sensor 230 can be implemented with a single integrated circuit that receives light and generates three inputs: a first signal representing the red component of the received light, a second signal representing the green component of the received light, and a third signal representing the blue component of the received light.

The color change detection mechanism (CCDM) 240 is coupled to the color sensor 230 and receives the signals generated by the color sensor 230. For example, the CCDM 240 receives the first signal 233, second signal 235 and third signal 237 from the color sensor 230 and based thereon determines whether the indicator 210 has changed color.

In one embodiment, the CCDM 240 compares the color sensor signals (233, 235, 237) with reference signals that correspond to the target color 218 and based on this comparison determines whether the color of the indicator 210 has changed to the target color 218. The color change detection mechanism (CCDM) 240 is described in greater detail hereinafter with reference to FIG. 3 and FIG. 4.

When it has been determined that the color of the indicator 210 has changed to the target color 218, the CCDM 240 can optionally assert an alarm signal 244. The alarm 250 is optionally provided and coupled to the CCDM 240 to receive the alarm signal 244. When the alarm signal 244 is asserted, the alarm 250 generates notifies those in the vicinity of the radiation that the presence of radiation has been detected. The alarm 250 can be, but is not limited to, a visual alarm that generates a visual alert or cue, an audible alarm that generates an audible alert or cue, and other alarm (e.g., an alarm incorporated into a pager or cellular telephone that vibrates when radiation is detected).

When it is determined that the indicator has changed to the target color 218, the CCDM 240 can also selectively assert a remedial measure (RM) signal 248. The remedial measures unit 260 is optionally provided and coupled to the CCDM 240 to receive the RM signal 248. When the RM signal 248 is asserted, the remedial measures unit 260 initiates one or more remedial measures (e.g., venting the area, stopping the manufacturing process, etc.) to eliminate or mitigate the presence of the radiation.

In another embodiment, the color sensor 230 is integrated with the CCDM 240. In this embodiment, the CCDM 240 employs the color sensor 230 to receive light reflected from the indicator 210 and based thereon to generate one or more signals that represent the received light. The CCDM 240 then utilizes the signals generated by the color sensor 230 to determine whether the indicator 210 has changed to the target color 218. Once it is determined that the analyte is present, the CCDM 240 can generate an alarm signal 244 to activate an alarm 250 or a remedial measure (RM) signal 248 to initiate remedial measures 260. In yet another embodiment, both the color sensor 230 and the light source 220 are integrated with the CCDM 240.

Color Change Detection Mechanism (CCDM) 140/240

FIG. 3 illustrates a block diagram of the color change detection mechanism (CCDM) 140, 240 according to one embodiment of the invention. The color change detection mechanism (CCDM) 140, 240 includes a first color sensor comparator (FCSC) 310, a second color sensor comparator (SCSC) 320, a third color sensor comparator (TCSC) 330, and a color determination mechanism (CDM) 340.

The first color sensor comparator (FCSC) 310 receives the output 312 of the first color sensor and a first predetermined color value 314 and determines whether the output 312 of the first color sensor is in a first predetermined relationship (e.g., greater than, greater than or equal to, less than, less than or equal to, or equal to) with the first predetermined color value 314. The FCSC 310 generates a first comparison signal 318 that in one embodiment indicates whether the output 312 is equal to or greater than the first predetermined color value 314.

The second color sensor comparator (SCSC) 320 receives the output 322 of the second color sensor and a second predetermined color value 324 and determines whether the output 322 of the second color sensor is in a first predetermined relationship (e.g., greater than, greater than or equal to, less than, less than or equal to, or equal to) with the second predetermined color value 324. The SCSC 320 generates a second comparison signal 328 that in one embodiment indicates whether the output 322 is equal to or greater than the second predetermined color value 324.

The third color sensor comparator (TCSC) 330 receives the output 332 of the third color sensor and a third predetermined color value 334 and determines whether the output 332 of the third color sensor is in a first predetermined relationship (e.g., greater than, greater than or equal to, less than, less than or equal to, or equal to) with the third predetermined color value 334. The TCSC 330 generates a third comparison signal 338 that in one embodiment indicates whether the output 332 is equal to or greater than the third predetermined color value 334.

The color determination mechanism (CDM) 340 receives the first comparison signal 318, a second comparison signal 328 and a third comparison signal 338 and based thereon determines whether the color of the indicator has changed to the target color and selectively generates the alarm signal 144, 244, the RM signal 148, 248, or both.

The first color can be selected to generate a first predetermined transmittance versus wavelength plot, profile, or graph. Preferably, the second color or target color can be selected to generate a second predetermined transmittance versus wavelength plot, profile, or graph that is significantly different from the first predetermined transmittance versus wavelength plot so that the change from the first color to the second color can be easily detected by the CCDM according to the invention. The first color can be for example, a white color, which provides a generally uniform and high transmittance across wavelengths or a black color, which provides a generally uniform and low transmittance across wavelengths. For example, the target color may be, but is not limited to, red, green, blue, cyan, magenta, yellow, or a combination thereof.

The color determination mechanism 340 receives the output determined by the comparators 310, 320, 330, and based thereon determines whether the color of the indicator has changed into the target color.

For example, when the indicator is of a first color, the color sensors receive about the same light intensity (i.e., the red color sensor, green color sensor, and blue color sensor receive about the same amount of light, which is converted to a corresponding photocurrent and voltage). However, when the indicator changes to a target color (e.g., red), the red sensor suddenly receives more light (e.g., red light) and generates a corresponding signal (e.g., a photocurrent and voltage) that is greater than the output of the green sensor and the blue sensor. In one embodiment, the output (e.g., voltage signal) of a predetermined sensor (e.g., the red sensor) is compared to a reference value that corresponds to the target color to determine whether the indicator has changed color. In an alternative embodiment, a combination of one or more of the following: the output of the red sensor, the output of the green sensor and the output of the blue sensor, are utilized to determine whether the indicator has changed color.

Similarly, when the target color is green, the output of the green sensor can be compared to a predetermined level (e.g., reference level) to determine whether the indicator has changed to a green color. It is noted that the output of the red sensor and the output of the blue sensor can also be used in conjunction with the output of the green sensor to determine whether the indicator has changed to a green color.

Similarly, when the target color is blue, the output of the blue sensor can be compared to a predetermined level (e.g., reference level) to determine whether the indicator has changed to a blue color. It is noted that the output of the red sensor and the output of the blue sensor can also be used in conjunction with the output of the green sensor to determine whether the indicator has changed to a blue color.

In one embodiment, the following steps are executed: 1) determine if measured red value is greater than predetermined red value; 2) determine if measured green value is greater than predetermined green value; 3) determine if measured blue value is greater than predetermined blue value; 4) when all the above determination steps or conditions are met, an alarm or alert is generated. In one embodiment, when the measured values are within a predetermined percent (e.g., the measured values (red, green, blue) are within 5% or 10% of the predetermined red, green, blue values), a preliminary alert may be generated. This preliminary alert can be a message that indicates that there is an increase in a particular gas or an increase in radiation in the environment although still less than the minimum amount to trigger the alarm.

Color Change Detection Processing

FIG. 4 is a flow chart illustrating the processing steps performed by the color change detection mechanism of FIG. 3 according to one embodiment of the invention. In step 410, an indicator that reflects a first color in the absence of a predetermined gas and a second color in the presence of the predetermined gas is provided. In step 420, a change in color of the indicator from the first color to the second is detected by a color sensor, for example.

In step 420, the color change detection mechanism according to the invention utilizes a color sensor in the following manner. The color sensor generates voltages from its output pins when a certain amount of color is shone on the color sensor. In one embodiment, the color sensor has three output pins: red output pin, green output pin and blue output pin. These output pins each generates a voltage that corresponds to the amount of color light received.

When a red light is shone on the sensor, although each output pin generates a signal (e.g., output voltage), the red output pin generates the highest output. When more red is shone onto the color sensor, there is a higher output from the red output pin. When something in between red and green (e.g., yellow light) is shone onto the color sensor, the red output pin and the green output pin generate approximately the same amount of output. The color change detection mechanism according to the invention compares the outputs of the output pins of the color sensor to a predetermined reference (e.g., a predetermined red output signal, a predetermined green output signal, and a predetermined blue output signal) that represents a color indicating the presence of an analyte.

In one embodiment, a controller (e.g., a micro-controller) is programmed with predetermined reference values for each of the outputs of the color sensor. When the values generated by the color sensor, which are based on measurement of received light, match these reference values, the target gas has been detected.

In one example, laboratory tests reveal that carbon dioxide (CO₂) reacts on a certain chemical strip to exhibit a bluish color. The color sensor detects the color change of the strip and generates an output at its output pins that represents this bluish color. The output signal (e.g., the voltage signals generated by the three output pins) is then stored into a memory. When the color sensor is subsequently deployed in an environment and detects that the color of a chemical strip generates an output signal that is similar to the previously stored values, an alarm may be triggered or some other remedial action may be taken.

In another example, the color sensor in the field detects a color change of the strip, and the color sensor generates the following output voltages: R=0.6V, G=1.2V, B=3.2V. These voltages are compared to the reference values previously-stored in the controller. For example, the following may be previously-stored: a) Oxygen: R=0.6V, G=1.2V, B=3.2V; b) Argon: R=1.2V, G=1.2V, B=0.3V; and c) CO2: R=3.2V, G=0.2V, B=1.2V. By comparing the measured color with the reference values, the gas is determined to be oxygen, and the user is notified via alarm or alert. In this example, an integrated circuit that includes the mechanisms according to the invention has an operating or supply voltage of 5V. When exposed to white light, the output of the color sensor can be the following: (R, G, B)=(4V, 4V, 4V).

In step 430, an alarm is selectively generated when the color change of the indicator from the first color to the second color. For example, for many monitoring applications, when the presence of an analyte is detected, the monitoring instrument provides an alarm to warn nearby personnel. In step 440, at least one remedial measure is selectively activated when the color change of the indicator from the first color to the second color. This remedial measure can be, for example, increasing the ventilation in the area or space or stopping the process that may be the cause of the analyte (e.g., gas/radiation).

The gas/radiation detector that employs color change detection mechanism according to the invention can be utilized to detect potentially dangerous gas mixtures (e.g. combustible gases, toxic gases, and excessively high or low oxygen concentrations) that may be found, for example, in a work place environment. Monitoring instruments for safety and environmental applications can employ the color change detection mechanisms according to the invention to detect a wide range of potential hazards.

For example, the color change detection mechanisms according to the invention can be implemented in monitoring instruments for other applications including environmental monitoring, pollution control (e.g. volatile organic compounds (VOCs), oxides of nitrogen, ozone, particulates etc.) and indoor air quality (e.g. carbon dioxide, relative humidity, temperature).

The color change detection mechanisms according to the invention can be implemented in portable instruments that are designed to be hand-held, that are designed to be worn by the user, or that are designed to be easily transported from one location to another. The color change detection mechanisms according to the invention can also be implemented in non-portable instruments that are typically mounted in a fixed location and that provide monitoring at that location.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. An apparatus for detecting a presence of a target gas comprising:
a) an indicator that changes color from a first color to a second color in the presence of the target gas;
b) a color sensor that receives the light reflected from the indicator and based thereon generates at least one signal that represents the received light; and
c) a color change detection mechanism coupled to the color sensor that receives the signal generated by the color sensor and based thereon determines whether the indicator has changed to the second color.

2. The apparatus of claim 1 further comprising:
d) a light source that illuminates the indicator.

3. The apparatus of claim 1 wherein the indicator includes a chemical that reflects the second color when exposed to the target gas.

4. The apparatus of claim 1 wherein the color change detection mechanism compares the signal generated by the color sensor to a predetermined reference signal and based thereon determines whether the indicator has changed to the second color.

5. The apparatus of claim 1 wherein the color change detection mechanism selectively asserts an alarm signal when the color of the indicator changes to the second color.

6. The apparatus of claim 5 further comprising:
an alarm coupled to the color change detection mechanism that receives the alarm signal and based thereon selectively notifies a user of the presence of the target gas.

7. The apparatus of claim 6 wherein the alarm generates one of an audible alert and a visual alert.

8. The apparatus of claim 1 wherein the color sensor includes a red sensor that receives red light and generates a signal representing the received red light, a green sensor that receives green light and generates a signal representing the received green light, and a blue sensor that receives blue light and generates a signal representing the received blue light.

9. An apparatus for detecting radiation comprising:
a) an indicator that changes color from a first color to a second color in the presence of radiation; and
b) a color sensor that receives the light reflected from the indicator and based thereon generates at least one signal that represents the received light; and
c) a color change detection mechanism coupled to the color sensor that receives the signal generated by the color sensor and based thereon determines whether the indicator has changed to the second color.

10. The apparatus of claim 9 further comprising:
d) a light source that illuminates the indicator.

11. The apparatus of claim 9 wherein the indicator includes a chemical that reflects a predetermined color when exposed to the radiation.

12. The apparatus of claim 9 wherein the color change detection mechanism compares the signal generated by the color sensor to a predetermined reference signal and based thereon determines whether the indicator has changed to the second color.

13. The apparatus of claim 9 wherein the color change detection mechanism selectively asserts an alarm signal when the color of the indicator changes to the second color.

14. The apparatus of claim 13 further comprising:
an alarm coupled to the color change detection mechanism that receives the alarm signal and based thereon selectively notifies a user of the presence of the target gas.

15. The apparatus of claim 14 wherein the alarm generates one of an audible alert and a visual alert.

16. The apparatus of claim 9 wherein the color sensor includes a red sensor that receives red light and generates a signal representing the received red light, a green sensor that receives green light and generates a signal representing the received green light, and a blue sensor that receives blue light and generates a signal representing the received blue light.

17. A method for using a color sensor to detect an analyte comprising:
a) providing an indicator that reflects a first color in the absence of the analyte and a second color in the presence of the analyte;
b) detecting the change from the first color to the second color by utilizing the color sensor; and

18. The method of claim 17 wherein detecting the change from the first color to the second color by utilizing a color sensor includes
receiving light reflected from the indicator; and
determining based on the received light whether the indicator has changed to the second color detecting.

19. The method of claim 17 wherein detecting the change from the first color to the second color by utilizing a color sensor includes one of receiving light reflected from the indicator; and
determining based on the received light whether the indicator has changed to the second color detecting within a predetermined duration.

20. The method of claim 17 comprising:
c) selectively generating an alarm when the change from the first color to the second color has been detected.
